(19) United States
(12) Patent Application Publication
(10) Pub. No.: US 2006/0055561 A1
(43) Pub. Date: Mar. 16, 2006

(54) Automatic speed violation detection and response system using wireless communication, positioning and RF ID

(76) Inventors: Tayeb A. Kamali, Abu Dhabi (AE); Hamad Odhabi, Abu Dhabi (AE); Senthil Nathan, Abu Dhabi (AE); Anand Kumar, Abu Dhabi (AE)

Correspondence Address: Abu Dhabi Men's College;Higher Colleges of Technology, Al Saada Street, P.O. Box 25035, Abu Dhabi, AE

(21) Appl. No.: 10/937,274

(22) Filed: Sep. 10, 2004

(51) Int. Cl. G08G 1/01; G08B 1/08; G08G 1/123

(52) U.S. Cl. 340/936; 340/539.17; 340/988

(57) ABSTRACT

An automatic mobile speed violation detection and response system for identifying vehicles traveling in excess of a predetermined speed and providing a response to this violation is proposed. The mobile speed violation detection device includes: measurement of target vehicle speed and outputting signal indicative of the measured speed; capturing license plate data on the RF ID tag affixed to the target vehicle when vehicle exceeds the predetermined speed; identifying the location of the speed violating vehicle; tagging the captured RF ID based license plate data with vehicle speed and location data; wireless communication of transmitting speed, license plate data, location data and local speed limit to and from the information system. The system includes an information system that performs long term statistical analysis, short term statistical analysis, automatic speed intervention, automatically issues tickets and automatically issues immediate warning to speed violators and provides predetermined local speed limits.

### CROSS REFERENCE TO RELATED APPLICATIONS

Not Applicable

### COPYRIGHT STATEMENT

Not Applicable

### FEDERAL RESEARCH STATEMENT

Not Applicable

### APPENDIX DATA

### OTHER REFERENCES

[1] http://www.ericsson.com/mobilityworld/sub/open/technologies/mobile_positioning/about /mps_system_overview
[2] http://www.rfidnews.org/news/2004/06/10/rfidenabled-license-plates-to-identify-uk-vehicles/
[3] U.S. Pat. No. 6,696,978 “Combined laser/radar-video speed violation detector for law enforcement” Feb. 24, 2004
[4] U.S. Pat. No. 6,606,033 “Information System” Aug. 12, 2003
[5] Performance and reliability of Radio Frequency Identification (RF ID), Master's Thesis in Information and Communication Technology, Hussain Al-Mousawi, Agder University College, Norway, 2004.

### BACKGROUND OF INVENTION

There exist today speed violation detection devices that include a speed radar and visual cameras. Wired connectivity for such devices to the Traffic Central Information System and fixed location devices lack the ease of installing networked devices at new locations. RF ID technology has been used for transportation, personnel access, animals, industrial and business applications; this technology has also been used for toll collection, access control and a wide variety of applications in commerce [5]. Recently, RF ID technology has been used in e-Plates project [2]: active (battery powered) RF ID tags are embedded in the license plates to identify vehicles in real time. This has enabled reliable identification of any vehicle, anywhere, whether stationary or mobile, and in all weather conditions.

### SUMMARY OF INVENTION

The death rate due to traffic accidents in UAE is quite high. One of the most common scenarios is that the drivers are familiar with fixed locations of cameras and slow down as they approach the cameras. If the complete speed violation detection unit can be made mobile, the unit can be placed anywhere on the road or on a police vehicle. Furthermore, if a speed violator is driving dangerously in a consistent manner, the nearest police vehicle can be automatically dispatched to the extrapolated position of the dangerous driver and vehicle.

This invention proposes using the existing concept of speed radars along with RF ID Technology based vehicle identification to detect speed violation. The RF ID technology based vehicle identification would require less bandwidth over the air than a photographic or video image of the vehicle and license plate. This invention also proposes to add position location capability (e.g., Global Positioning System—GPS, Ericsson's Mobile Positioning System) for the new speed violation detection device—this would provide mobility for the new device and capability to locate the position of speed violation. Traffic Central Information System provides the mobile speed violation detection devices with the predetermined speed limit at the location of the mobile device. The invention also proposes to transmit the speed violation information to the Traffic Central Information System through wireless technology (e.g., GSM, 3G). At Traffic Central Information System, the information is processed and used for long term statistical analysis, short term statistical analysis, issuing tickets, immediate warning to speed violator, and automatic speed intervention by nearest police vehicle.

### BRIEF DESCRIPTION OF DRAWINGS

FIG. 1 illustrates a schematic view of a preferred implementation of the system for identifying vehicles traveling in excess of a predetermined speed and corresponding response of the present invention.

FIG. 2 illustrates the mobile speed violation detection device of FIG. 1 on the roadside.

FIG. 3 illustrates the Traffic Central Information System in FIG. 1 and FIG. 2.

### Brief Description of Sequences

Not Applicable

### DETAILED DESCRIPTION

Although this invention is applicable to numerous and various types of vehicles, it has been found particularly useful in the environment of automobiles. Therefore, without limiting the applicability of the invention to automobiles, the invention will be described in such environment.

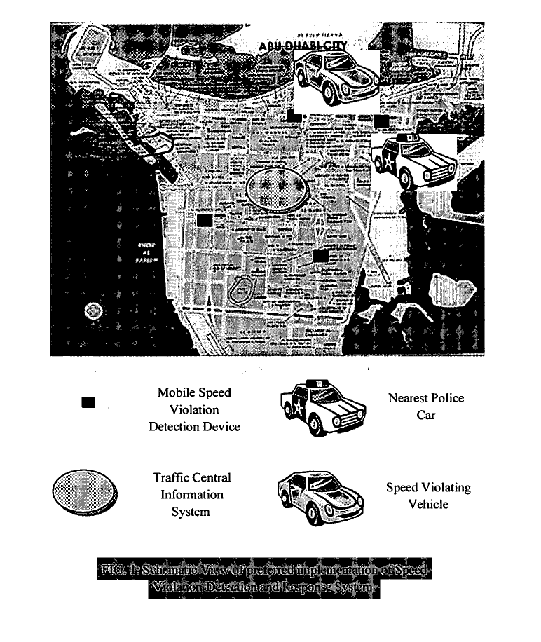

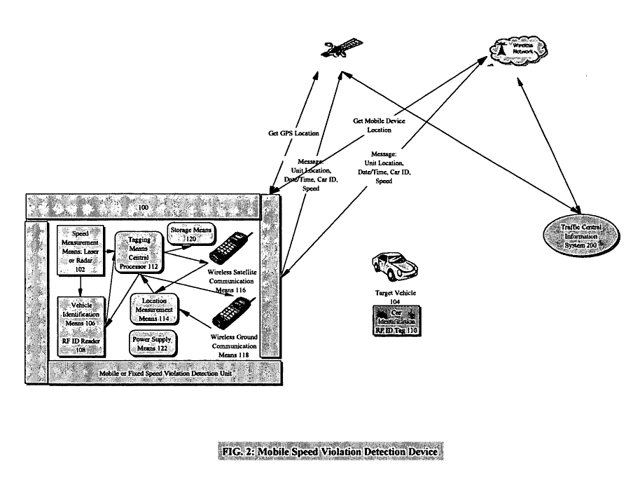

Referring now to FIGS. 1 and 2, there is illustrated a preferred device for identifying vehicles traveling in excess of a predetermined speed V, the device being generally referred to by reference numeral 100. This device can be a handheld unit, stationary fixed unit, or fixed to a vehicle, such as a law enforcement vehicle.

Device 100 comprises a speed measurement means 102, such as a radar or laser speed detector. The speed measurement means measures the speed of a target vehicle 104 and outputting a signal indicative of the measured speed. The function and use of such speed measurement means 102 are well known in the art. The signal indicative of the measured speed of the target vehicle 104 can be converted into alphanumeric data.

The device 100 comprises a vehicle identification means 106 that comprises an RF ID reader 108 operatively connected to the speed measurement means 102 for capturing the alphanumeric license plate data on the RF ID tag 110 affixed to the target vehicle 104 when the target vehicle 104 exceeds the predetermined speed, V. The RF ID reader 108 is activated by a signal either directly from the speed measurement means 102 or through a central processor 112. Such a signal may be automatically generated upon exceeding the predetermined speed V or upon manual input by the operator of the device 100.

Device 100 comprises a location measurement means 114 that determines the location of device 100 and thereby the location of the speed violating target vehicle 104. The location measurement means 114 determines the GPS location of device 100 and speed violating target vehicle 104 using Wireless Satellite Communication means 116; alternatively, the location measurement means 114 can determine the location of device 100 and speed violating target vehicle 104 using Wireless Ground Communication means 118 (e.g., Ericsson's Mobile Positioning System with GSM or 3G). The signal indicative of the location measurement can be converted to alphanumeric data.

Device 100 comprises Wireless Satellite Communication Means 116 and/or Wireless Ground Communication Means 118. Wireless Satellite Communication Means 116 can communicate via satellite to get GPS location and send speed violation data (speed measurement data, Vehicle identification in RF ID tag and location data) using messaging (e.g., SMS) or dial up. The speed violation data can always be sent via satellite or where ground wireless communication network is not available. Wireless Ground Communication Means 118 can communicate via ground wireless network (e.g., GSM or 3G) to get location data (e.g., using Ericsson's network based Mobile Positioning System) and send speed violation data (speed measurement data, Vehicle identification in RF ID tag and location data) using messaging (e.g., SMS) or dial up. Wireless Ground Communication Means 118 will be used to determine location of device 100 and speed violating target vehicle 104 if the wireless network provides this capability.

Device 100 comprises a means, such as the central processor 112 for tagging the alphanumeric vehicle identification data with the signal indicative of the measured speed V of the target vehicle 104 and signal indicative of the location measurement of device 100 and target vehicle 104. The vehicle identification data of target vehicle 104, the speed of target vehicle 104 and location of target vehicle 104 could all be alphanumeric in nature. The speed violation data of individual target vehicles 104 can be stored in storage means 120 and the collection of speed violation data can be forwarded by the central processor 112 to the traffic central information system 200 at regular intervals (e.g., every hour): this could reduce wireless network traffic. Alternatively, the speed violation data can be sent immediately to traffic central information system 200—this is essential for automatic speed intervention.

Device 100 comprises a storage means (this could be a hard disk or a memory) to store speed, license plate data and location data of speed violating vehicle.

Device 100 also comprises a power supply means (e.g., a battery) that provides sufficient power supply for device 100 to operate continuously for a certain period of time (e.g., 24 hours or 48 hours).

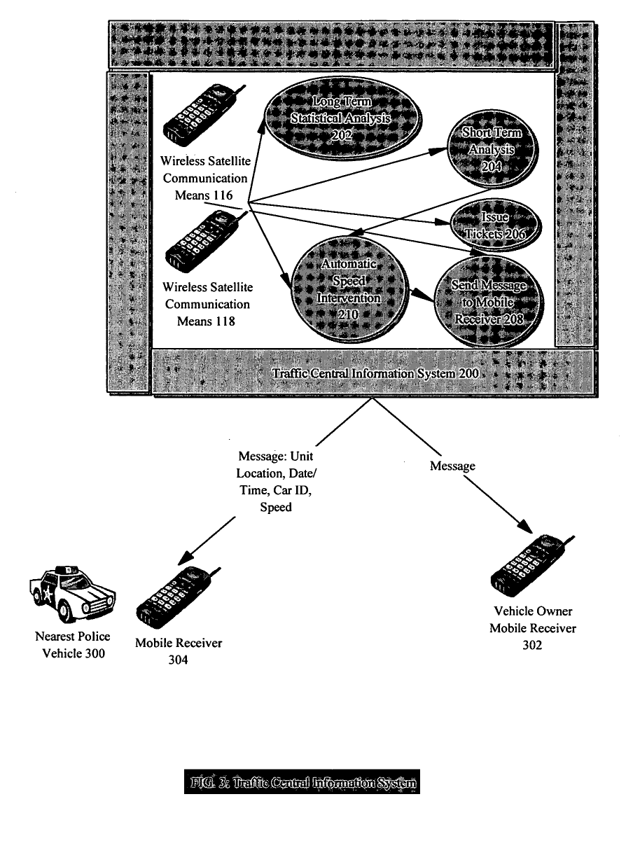

Referring to FIGS. 1, 2 and 3, there is illustrated the Traffic Central Information System. This system is referred to as numeral 200.

System 200 comprises Wireless Satellite Communication Means 116 or Wireless Ground Communication Means 118. Wireless Satellite Communication Means 116 can communicate via satellite to receive speed violation data (speed measurement data, Vehicle identification in RF ID tag and location data) using SMS or dial up. The speed violation data can always be sent via satellite or where ground wireless communication network is not available. Wireless Ground Communication Means 118 can communicate via ground wireless network (e.g., GSM or 3G) to receive speed violation data (speed measurement data, Vehicle identification in RF ID tag and location data) using SMS or dial up.

System 200 comprises a data processor (could be a computer) 202 that performs long term statistical analysis. Such analysis are well known in the art.

System 200 comprises a data processor 204 (could be a computer) that performs short term statistical analysis. Such analysis are well known in the art.

System 200 comprises a data processor 206 (could be a computer) that issues tickets. This function is well known in the art.

System 200 comprises a data processor 208 (could be a computer) that sends Message to Mobile Receiver. This function is well known in the art.

System 200 comprises a data processor 210 (could be a computer) that implements automatic speed intervention. This data processor would correlate speed violation data for a particular target vehicle 104 over devices 100 on the path followed by target vehicle 104 to determine consistent dangerous driving. Data processor 210 communicates with Vehicle Owner Mobile Receiver 302 of target vehicle 104 violating local predetermined speed limit through data processor 208. Data processor 210 also communicates with Mobile Receiver 304 in Nearest Police Vehicle 300 through data processor 208.

What is claimed is:

1. An automatic mobile speed violation detection and response system for law enforcement comprising
a mobile speed violation detection device comprising:
speed measurement means for measuring the speed of a target vehicle and outputting a signal indicative of the measured speed;
vehicle identification means that comprises an RF ID reader operatively connected to the speed measurement means for capturing the license plate data on the RF ID tag affixed to the target vehicle when the target vehicle exceeds the predetermined speed;
location measurement means for identifying the location of the said mobile speed violation detection device and the speed violating vehicle;
tagging means for tagging the captured RF ID based license plate data with the signal indicative of the measured speed of the target vehicle and location data;
a wireless satellite communication means and/or wireless ground communication means for transmitting speed, license plate data and location data to the information system and
also for mobile speed violation detection device to receive speed limit at current location of said mobile speed violation detection device.
a storage means for storing speed, license plate data and location data of speed violating vehicle to permit transmission of such data cumulatively at regular intervals of time.
a power supply means to permit mobile speed violation detection device to operate in remote location.
a traffic central information system that performs long term statistical analysis, short term statistical analysis, automatic speed intervention, automatically issues tickets and automatically issues immediate warning to speed violators based on different data collected for different mobile speed violation detection devices; this said information system provides predetermined speed limits for current location of said mobile speed violation detection device.

2. The mobile speed violation detection device of claim 1, wherein the tagging means comprises:
conversion means for converting the signals indicative of the measured speed of the target vehicle into alpha-numeric data

3. The traffic central information system as claimed in claim 1, provides data to the mobile speed violation detection device with the speed limit at the location of the said device.

4. The traffic central information system as claimed in claim 1, warns the vehicle occupant through a mobile phone when vehicle speed exceeds predetermined speed limit.

5. The traffic central information system as claimed in claim 1, in which is a data processor that performs short term analysis of speed data, RF ID based license plate data and location data from a predetermined number of mobile speed violation detection devices to determine consistent dangerous driving.

6. The traffic central information system as claimed in claim 1, determines dangerous driving as in claim 5, and identifies the police vehicle nearest to the current location of dangerous driving vehicle.

7. An information system as claimed in claim 1, communicates speed data, RF ID based license plate data and location data of dangerous driving vehicle to police vehicle nearest to current location of said dangerous driving vehicle as determined in claim 6 to provide automatic speed intervention.

8. The traffic central information system claimed in claim 1, automatically calculates long term statistics of based on operator input.

9. The traffic central information system claimed in claim 1, automatically issues ticket to the vehicle and driver exceeding predetermined speed limit.

10. The traffic central information system claimed in claim 1, comprises wireless satellite communication means or wireless ground communication means and communicates with mobile speed violation devices using these means.
